(19) United States
(12) Patent Application Publication
(10) Pub. No.: US 2024/0217400 A1
(43) Pub. Date: Jul. 4, 2024

(54) CHILD CAR SEAT

(71) Applicant: Wonderland Switzerland AG, Steinhausen (CH)

(72) Inventors: David A. LEHMAN, Lancaster, PA (US); Kyle S. MASON, Lititz, PA (US); Andrew J. TAYLOR, Mohnton, PA (US); Curtis M. HARTENSTINE, Birdsboro, PA (US); Andrew j. HORST, West Lawn, PA (US)

(73) Assignee: Wonderland Switzerland AG, Steinhausen (CH)

(21) Appl. No.: 18/557,377

(22) PCT Filed: Apr. 28, 2022
(86) PCT No.: PCT/US2022/026710

§ 371 Date: Oct. 26, 2023

Related U.S. Application Data
(60) Provisional application No. 63/181,577, filed on Apr. 29, 2021.
(60) Provisional application No. 63/221,971, filed on Jul. 15, 2021.
(60) Provisional application No. 63/255,895, filed on Oct. 14, 2021.

(51) Int. Cl. B60N 2/28

(52) U.S. Cl. CPC B60N 2/2821; B60N 2/2866; B60N 2/2872

(57) ABSTRACT

In one example, a child car seat for a vehicle has a main body with seatback, a seating surface that extends forward from the seatback, and a recline foot. The recline foot has a front end that defines an engagement region that engages a vehicle seat, and a rear end disposed behind the front end. The rear end is coupled to the main body such that the recline foot pivots relative to main body about a pivot axis to transition the main body between at least one reclined position and at least one inclined position. The rear end has a rigid portion, and the car seat has a deformable body affixed to the rigid portion. The deformable body engages the vehicle seat and deforms under a lower force than the rigid portion.

### CROSS-REFERENCE TO RELATED APPLICATIONS

This application claims priority to U.S. Provisional Patent Application Nos.: (i) 63/181,577, filed Apr. 29, 2021; (ii) 63/221,971, filed Jul. 15, 2021; and (iii) 63/255,895, filed Oct. 14, 2021, the disclosures of which are all hereby incorporated by reference as if set forth in its entirety herein.

### TECHNICAL FIELD

The present disclosure relates generally to child car seats and, in particular, to child car seats having multiple use configurations, a reclining configuration, and crash safety features.

### BACKGROUND

Some child car seats currently available on the market have multiple use configurations that allow for the seats to continue to be used as a child grows. For example, some child car seats can be selectively used in any one or more of: (1) a rear facing, reclined configuration for infants, (2) a forward facing, reclined configuration for toddlers, (3) a forward facing, high-back booster configuration for children weighing between, e.g., 40 pounds and 100 pounds, and (4) a forward facing, backless booster configuration for children weighing between, e.g., 40 pounds and 120 pounds.

### SUMMARY

In one example, a child car seat for a vehicle comprises a main body and a booster seat. The main body comprises a seatback having a first sidewall and a second sidewall that are spaced from one another so as to define a space therebetween for a child's upper body. The booster seat is configured to be removably attached to the main body. The booster seat comprises first and second arms that are spaced from one another, and a seating surface between the first and second arms. The first arm is configured to removably attach to the first sidewall at an interface between the first arm and the first sidewall. The second arm and the second sidewall can likewise be removable attachable to each other. Various coupling configurations or interfaces can be provided between the sidewalls and the arms. The coupling interface defined via the sidewalls of the main body can increase the structural rigidity of the child car seat.

In another example, a child car seat for a vehicle comprises a main body and a booster seat. The main body comprises a seatback and at least one attachment member that extends from the seatback. The booster seat comprises a seating surface, a recess below the seating surface that is configured to receive the at least one attachment member, and at least one foot that extends downwards from the seating surface and into the recess at a rear end of the seating surface. The at least one foot is configured to support the rear end of the seating surface when the booster seat is decoupled from the at least one attachment member. Based on this configuration, the booster seat can be used in a variety of settings, which do not require mounting or installation with a child car seat. For example, the booster seat can be used as a standalone seat for a child, or can be placed on a seating surface of a chair or seating booth.

In yet another example, a child car seat for a vehicle comprises a main body and a booster seat. The main body comprises a seatback, and at least one attachment member that extends from the seatback along a forward direction. The main body defines at least one engagement surface. The booster seat is configured to be removably attached to the main body. The booster seat comprises a release latch having an engagement surface and an actuator surface. The engagement surface is configured to releasably engage the engagement surface of the main body so as to fix the booster seat and main body to one another. The actuator surface can be disposed at an outer side surface or a front surface of the booster seat. The actuator surface can be provided as a push button, or any other type of actuator.

In even yet another example, a child car seat for a vehicle comprises a main body, a booster seat, and a harness. The main body comprises a seatback and at least one attachment member that extends from the seatback. The booster seat comprises a seating surface. The booster seat is configured to be coupled to the at least one attachment member such that the seating surface is disposed above the at least one attachment member. The booster seat defines a pair of lap belt openings that extend into a rear end of the booster seat. The harness comprises a crotch buckle, and first and second straps having first and second lap belt portions, respectively, that are configured to rest over a lap of a child. The harness can comprise, for each lap belt portion of the first and second lap belt portions, a stiffener that is attached to the lap belt portion, and extends with the lap belt portion from below the seating surface, out through a corresponding one of the lap belt openings, and above the seating surface.

In even yet still another example, a child car seat for a vehicle comprises a main body, a seating surface, and a recline foot. The main body comprises a seatback, and the seating surface extends forward from the seatback. The recline foot has a front end that defines an engagement surface configured to engage a vehicle seat, and a rear end disposed behind the front end. The rear end is coupled to the main body such that the recline foot is configured to pivot relative to main body about a pivot axis to transition the main body between at least one reclined position and at least one inclined position. The rear end has a rigid portion thereof that is not configured to engage the vehicle seat (i.e. the rigid portion can be positioned above the vehicle seat). The recline foot comprises a deformable body affixed to the rigid portion of the recline foot. The deformable body is configured to engage the vehicle seat and deform under a lower force than is required to deform the rigid portion, which helps absorb energy in the event of a collision of accident.

Various other configurations for a child car seat are disclosed herein.

### BRIEF DESCRIPTION OF THE DRAWINGS

The following description of the illustrative embodiments may be better understood when read in conjunction with the appended drawings. It is understood that potential embodiments of the disclosed systems and methods are not limited to those depicted.

FIG. 1 is a perspective view of a child safety seat according to one example;

FIG. 2 is a side view of the child safety seat of FIG. 1 in an upright position;

FIG. 3 is a side view of the child safety seat of FIG. 1 in a reclined position;

FIG. 4A is a perspective view of a main body of the child safety seat of FIG. 1 according to one example, with a booster seat removed;

FIG. 4B is another perspective view of a main body of the child safety seat of FIG. 1 according to one example, with the booster seat removed;

FIG. 4C is an enlarged perspective view of a crotch-buckle pocket of the main body of FIGS. 4A and 4B;

FIG. 4D is another perspective view of the main body according to one example;

FIG. 5 is a perspective view of a booster seat of the child safety seat of FIG. 1 according to one example;

FIG. 6A is another perspective view of the booster seat of FIG. 5;

FIG. 6B is another perspective view of the booster seat of FIG. 5;

FIG. 7A is a perspective view of a booster seat according to another example;

FIG. 7B is a perspective view of a booster seat according to another example;

FIG. 8A is a side view of a child safety seat with a booster seat shown in broken lines;

FIG. 8B is a bottom perspective view of the booster seat of FIG. 8A;

FIG. 9 is a perspective view of a main body of a child safety seat according to another example;

FIG. 10 is an enlarged view of a portion of the main body of FIG. 9;

FIG. 11 is a perspective view of a booster seat according to another example that is configured to be used with the main body of FIG. 9;

FIG. 12 is a bottom perspective view of the child safety seat of FIG. 1, with a recline mechanism of the seat being in an upright configuration;

FIG. 13 is a bottom perspective view of the child safety seat of FIG. 1, with the recline mechanism of the seat being in a reclined configuration;

FIG. 14 is a cross-sectional view of a portion of one side of the booster seat, taken along the line indicated in FIG. 6A, illustrating a release latch;

FIG. 15 is a cross-sectional view of a portion of the child safety seat of FIG. 1, illustrating an attachment of a harness to the child safety seat according to one example;

FIG. 16 is a cross-sectional view of a portion of the safety seat of FIG. 1, illustrating the attachment of the harness to the child safety seat according to FIG. 15;

FIG. 17 is an exploded perspective view of a recline base of the child safety seat according to one example;

FIGS. 18A-18F are side views of the child safety seat in different use positions;

FIG. 19 is a side view a position of the child safety seat on a vehicle seat during an accident, such as a front-end collision;

FIG. 20 is an enlarged perspective view of a portion of a first recline foot of the recline base of FIG. 17 with a separate energy absorbing body and a holder therefor;

FIG. 21 is an exploded perspective view of the energy absorbing body and the holder of FIG. 20; and

FIG. 22 is an enlarged perspective view of a portion of a first recline foot of the recline base of FIG. 17 with an integral energy absorbing material.

### DETAILED DESCRIPTION

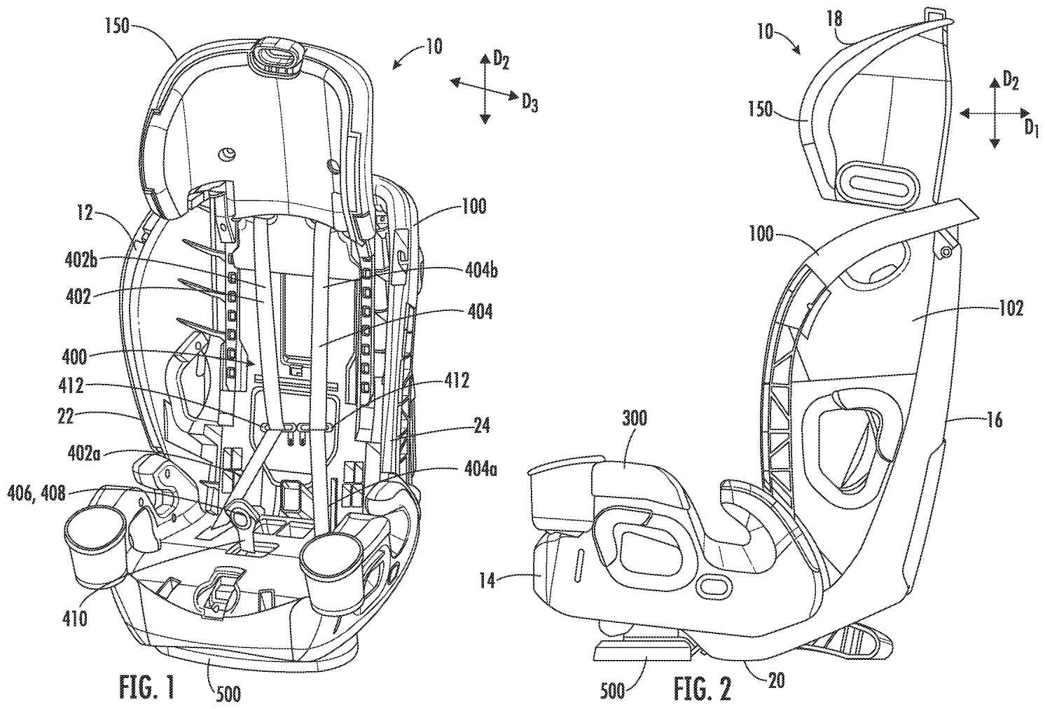

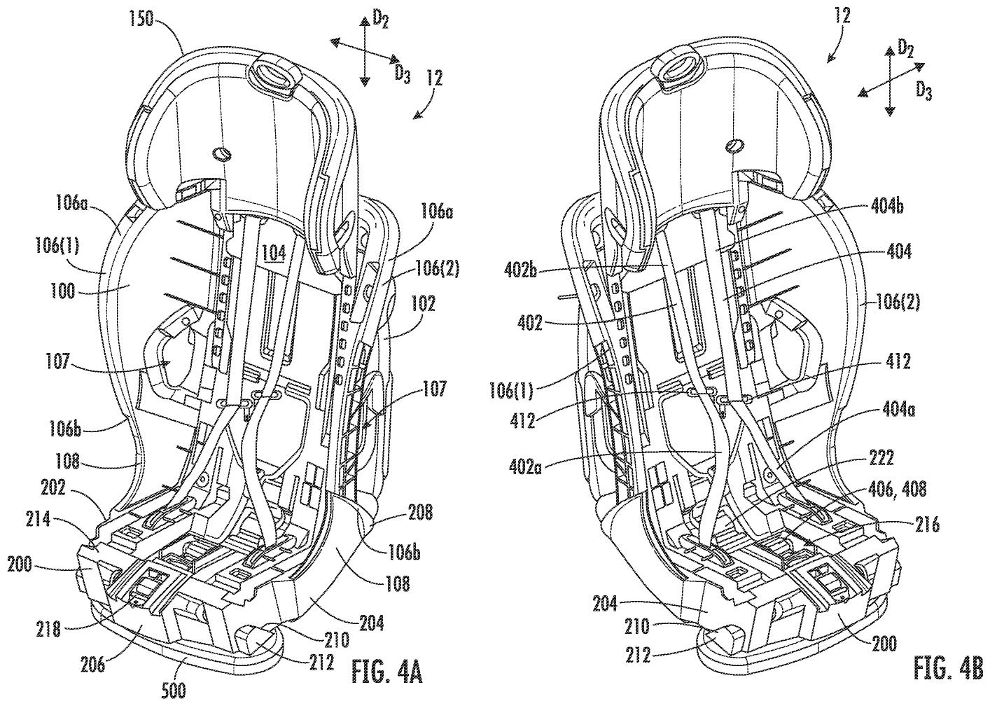

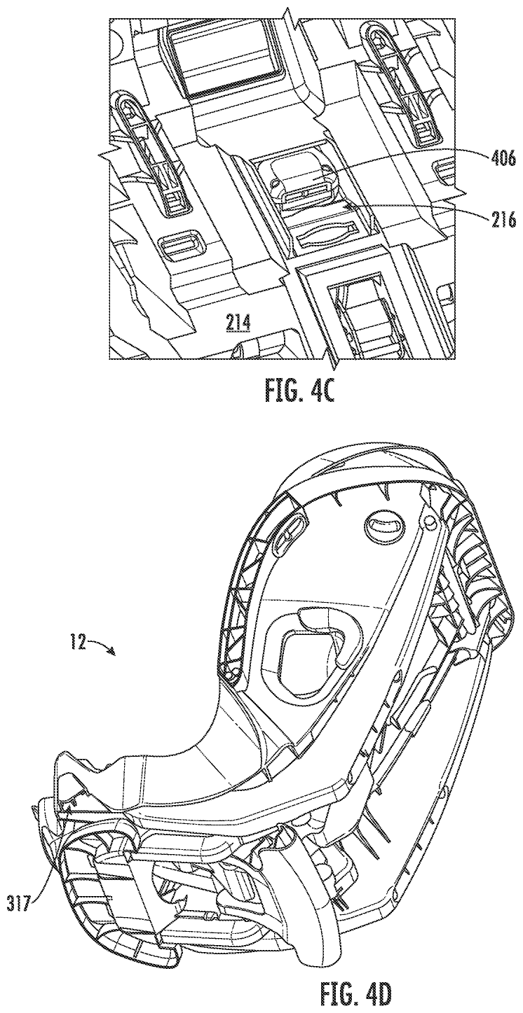

Referring to FIGS. 1 and 2, in general, a child safety seat 10 (also known as a child car seat) of this disclosure comprises a main body 12 and a booster seat 300 that is configured to removably attach to the main body. The main body 12 has a seatback 100, and at least one attachment member 200 (as shown in FIG. 4A) that extends from, and is attached to, the seatback 100. The attachment member 200 can form a bottom or base of the child safety seat 10.

The booster seat 300 and the attachment member 200 are configured to be removably coupled to one another. In some examples, the attachment member 200 can define a seat that extends forward from the seatback 100. In other examples, the attachment member 200 can define at least one protrusion, such as a rod, bar, or block of material, that extends forward from the seatback 100 and is configured to removably attach to the booster seat 300. The child safety seat 10 can comprise at least one seat cover (not shown) that covers a backrest surface 104 (shown in FIG. 4A) of the seatback 100, and a seating surface of the booster seat 300. As will be described in further detail below, the main body 12 and the booster seat 300 can include features that engage one another so as to improve structural rigidity of the child safety seat 10.

Referring to FIGS. 1 and 2, in some examples, the child safety seat 10 can comprise a harness 400 including a first strap 402, a second strap 404, and a crotch buckle 406. In such examples, the child safety seat 10 can be configured such that, when the booster seat 300 is coupled to the main body 12, the crotch buckle 406 is positioned above a seating surface 302 of the booster seat 300 to removably fasten to the first and second straps 402, 404.

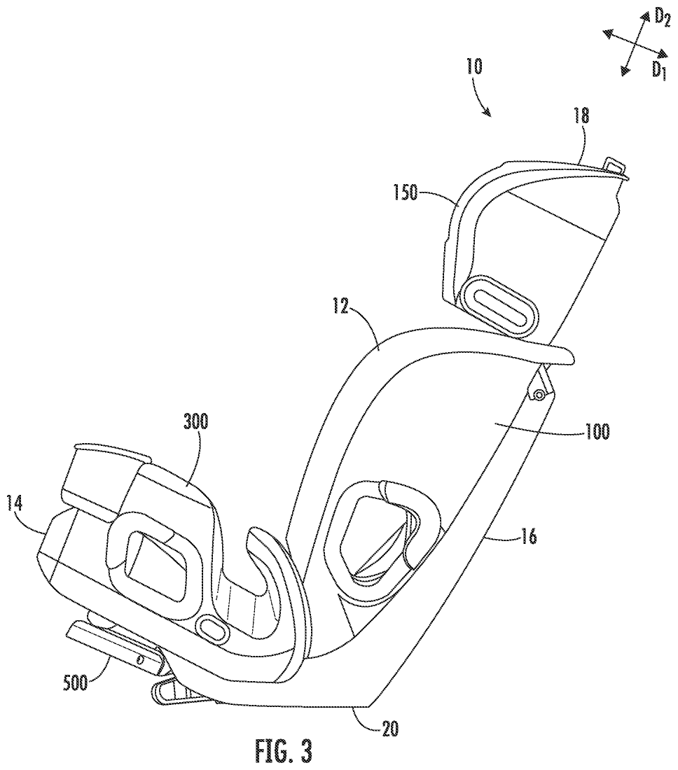

Additionally, or alternatively, in some examples, the child safety seat 10 can comprise a recline base 500. The recline base 500 can be attached to the attachment member 200 such that the main body 12 is configured to move relative to the recline base 500 between an upright position (as shown in at least FIG. 2) and a reclined position (as shown in at least FIG. 3).

In some examples, the child safety seat 10 can be a high-back booster seat that is configured to be converted to a backless booster seat by removing the booster seat 300 from the main body 12. In other examples, the child safety seat 10 can be a convertible car seat that is configured to be installed on a vehicle seat in a rearward facing direction when in the reclined position and a forward-facing direction when in the upright position, such as a 2-in-1 car seat, a 3-in-1 car seat, a 4-in-1 car seat, or an all-in-one car seat.

The features of the child safety seat 10 according to various examples of this disclosure will now be discussed in further detail. Referring more specifically to FIGS. 1 and 2, the main body 12 can comprise a front end 14 and a rear end 16 that are offset from one another. The front and rear ends 14, 16 can be offset along a first direction D₁ (which can correspond to a forward and backward direction when the child safety seat 10 is installed in a vehicle). The main body 12 can be configured such that a child faces in a direction from the rear end 16 towards the front end 14 when the child is seated properly in the child safety seat 10. The main body 12 can comprise an upper end 18 and a lower end 20 that are offset from one another. The upper and lower ends 18, 20 can be offset along a second direction D₂ (which can correspond to a vertical direction when the child safety seat 10 is installed in a vehicle), perpendicular to the first direction D₁. The main body 12 can be configured such that a child's head is positioned closer to the upper end 18 than the lower end 20 when the child is seated properly in the child safety seat 10. The main body 12 can comprise a first side 22 and a second side 24 that are offset from one another. The first and second sides 22, 24 can be offset along a third direction D₃ (which can correspond to a lateral direction when the child safety seat 10 is installed in a vehicle), perpendicular to both the first direction D₁ and second direction D₂. The main body 12 can be configured such that the child's arms are adjacent to the first and second sides 22 and 24, respectively, when the child is seated in the child safety seat 10.

Referring to FIGS. 4A and 4B, the seatback 100 has a seatback body 102. The backrest surface 104 is configured to support a child's back when the child is seated in the child safety seat 10. The backrest surface 104 can extend generally along the second direction D₂ and the third direction D₃. The seatback 100 can comprise a headrest 150. The headrest 150 can be attached to, or integral with, the seatback body 102. In some examples, the headrest 150 can be adjusted relative to the seatback body 102 along the second direction D₂ between an extended position and a retracted position.

The seatback 100 can comprise a pair of sidewalls 106(1) and 106(2) that are spaced from one another along the third direction D₃. The backrest surface 104 can be disposed between the sidewalls 106(1) and 106(2). The sidewalls 106(1) and 106(2) can extend out from the backrest surface 104 along the first direction D₁ so as to define a space therebetween that is dimensioned to receive a child's upper body. Each sidewall 106(1), 106(2) can define a belt guide opening 107 therethrough that is configured to receive at least a portion of a vehicle restraint to secure the main body 12 in a forward-facing position (i.e., facing the front of the vehicle).

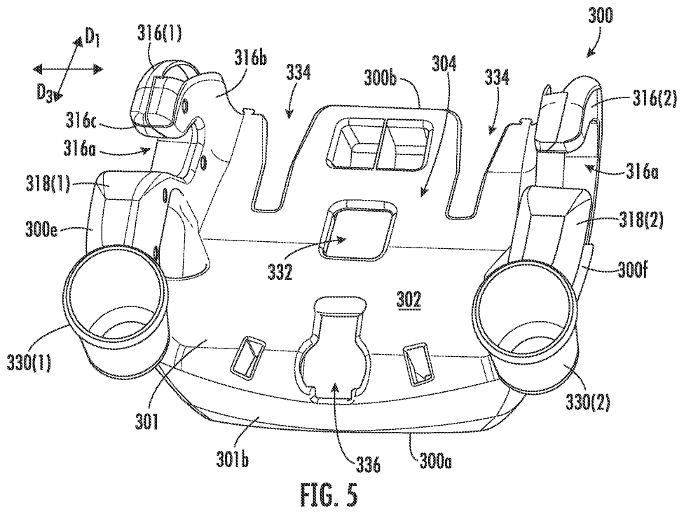

A first of the sidewalls 106(1) can be configured to couple to a first arm 316(1) (shown in FIG. 5) of the booster seat 300 at an interface between the first sidewall 106(1) and the first arm 316(1). In some examples, the coupling between the first sidewall 106(1) and the first arm 316(1) can limit or prevent flexing of the first sidewall 106(1) inwardly or outwardly along the third direction D₃. Similarly, in some examples, the second sidewall 106(2) can be configured to couple to a second arm 316(2) (shown in FIG. 5) of the booster seat 300 at an interface between the second sidewall 106(2) and the second arm 316(2). In one example, the interface between the sidewalls 106(1), 106(2) and the arms 316(1), 316(2) can be provided via a matching or complementary profile of these components. For example, the sidewalls 106(1), 106(2) can each define a curved recess or pocket, and the arms 316(1), 316(2) can each have a corresponding curved protrusion or extension that is configured to rest or be received within the curved recess or pocket of the sidewalls 106(1), 106(2). In some examples, the coupling between the second sidewall 106(2) and the second arm 316(2) can limit or prevent flexing of the second sidewall 106(2) inwardly or outwardly along the third direction D₃. The coupling between the sidewalls 106(1), 106(2) and the arms 316(1), 316(2) can generally limit or prevent (i) inward flexion of the arms towards the space dimensioned to support a child, or (ii) outward flexion of the arms away from the space dimensioned to support a child.

As shown in FIG. 4A, each sidewall 106(1) and 106(2) can have an upper end 106a and a lower end 106b that are spaced from one another along the second direction D₂. Each lower end 106b can be disposed adjacent to a corresponding arm 316(1), 316(2) (shown in FIG. 5) of the booster seat 300 when the booster seat 300 is coupled to the main body 12. In some examples, each lower end 106b can define a surface that faces a corresponding arm 316(1), 316(2). At least one lower end 106b, and preferably each lower end 106b, is configured to couple to a corresponding arm 316(1), 316(2) of the booster seat 300. For example, each lower end 106b can be configured to directly couple to a corresponding arm 316(1), 316(2) of the booster seat 300 such that the lower ends 106b contact the arms 316(1), 316(2).

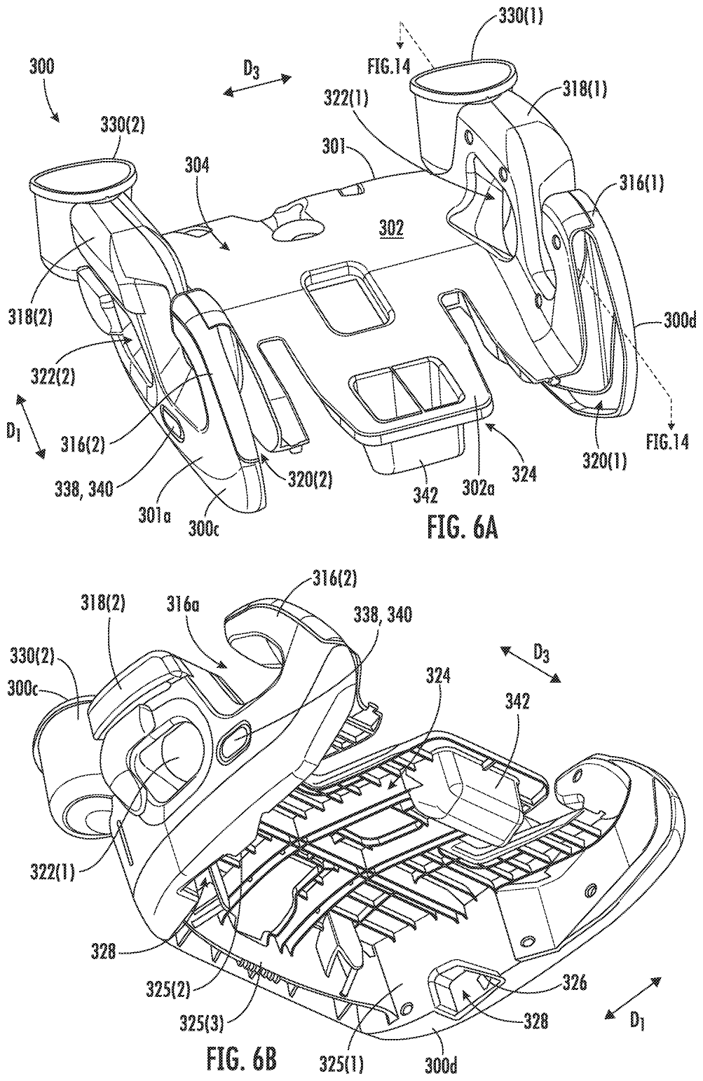

At least one lower end 106b, and preferably each lower end 106b, can comprise a first coupler 108 that is configured to couple to a second coupler of a corresponding arm 316(1), 316(2) of the booster seat 300. FIGS. 4A and 4B show one example in which each first coupler 108 is a protrusion or a rib, and each second coupler (320(1), 320(2) of FIG. 6A) of the booster seat 300 is an opening or pocket that is configured to receive a corresponding one of the first couplers 108 of the main body 12 therein.

Each first coupler 108 can extend downward from the lower end 106b of one of the sidewalls 106(1), 106(2). Additionally, or alternatively, each first coupler 108 can extend forward from the lower end 106b of one of the sidewalls 106(1), 106(2). In some examples, each first coupler 108 can extend from the lower end 106b of one of the sidewalls 106(1), 106(2) to the attachment member 200 such that the first coupler 108 is attached to both the lower end 106b of one of the sidewalls 106(1), 106(2) and to the attachment member 200. The first coupler 108 can therefore be formed as a connecting rib or structure between the lower end 106b of the sidewalls 106(1), 106(2) and the attachment member 200. In such examples, each first coupler 108 can also function as a stiffener that limits or prevents bending of the attachment member 200 relative to the seatback 100 within a plane that extends along the first and second directions D₁ and D₂. In one configuration, the main body 12 includes a male type coupler and the booster seat 300 includes a female type coupler. It will be understood that, in alternative examples, the couplers of both the main body 12 and the booster seat 300 could be otherwise configured. For example, each first coupler could define an opening, and each second coupler could define a protrusion that is configured to be received in a corresponding one of the first couplers.

The seatback 100 can be attached to the attachment member 200 adjacent the lower end 20. In some examples, the seatback 100 can be fixedly attached to the attachment member 200. For example, the seatback 100 can be positionally fixed to the attachment member 200 such that movement of the seatback 100 along any direction causes a corresponding movement of the attachment member 200. The attachment member 200 can be shaped as a tube, bar, block, or other suitable shape. FIGS. 4A and 4B show one example where the attachment member 200 is a single member having a plate-like shape that has a width along the third direction D₃ and a depth along the first direction D₁ that are each greater than a thickness of the attachment member 200 along the second direction D₂. The attachment member 200 can be configured as a seat having a seating surface or alternatively can be configured to not provide a seating surface. As an alternative example (not shown), the main body 12 could have a pair of attachment members that are spaced from one another along the third direction D₃, where each is shaped as a bar or tube that extends forward from the backrest surface 104 and each is received in a recess of the booster seat 300.

The attachment member 200 can be formed from a suitably rigid material and can be attached to the seatback 100 so as to limit or prevent bending of the attachment member 200 relative to the seatback 100 within a plane that extends along the first and second directions D₁ and D₂. Thus, the attachment member 200 and seatback 100 can be attached to one another so as to prevent a seating surface of the booster seat 300 and the backrest surface 104 from moving towards or away from one another. The attachment member 200 can extend from the seatback body 102 adjacent the lower end 20, and therefore, can define a protrusion from the seatback body 102. For instance, the attachment member 200 can extend from the seatback body 102 along a direction that extends from the rear end 16 towards the front end 14. The attachment member 200 can be configured to be removably received in a recess 324 (as shown in FIGS. 6A and 6B) of the booster seat 300. In other words, the attachment member 200 can be configured to be slid under the booster 300 and within the recess 324.

As shown in FIGS. 4A and 4B, the attachment member 200 can comprise a first side 202 and a second side 204 that are spaced from one another along the third direction D₃. The attachment member 200 can comprise a front end 206 and a rear end 208 that are spaced from one another along the first direction D₁. The rear end 208 can be attached to the seatback 100. The attachment member 200 can comprise an upper end 214. The upper end 214 can be covered by the booster seat 300 when the booster seat 300 is coupled to the attachment member 200. In some examples, the upper end 214 can define a seating surface, although in other examples, as shown in FIGS. 4A and 4B, the upper end 214 can be devoid of a seating surface.

At least one of the first and second sides 202 and 204 can define at least one engagement surface 210 that is configured to engage a corresponding engagement surface 326 defined on the booster seat 300 so as to guide movement of the booster seat 300 towards the attachment member 200 as the booster seat 300 is coupled to the attachment member 200 (e.g., align the booster seat 300 and attachment member 200 with one another). In one example, each engagement surface 210 can be angled upwards as it extends along a forward direction. The direction of this angle can be altered, as one of ordinary skill in the art would appreciate.

The engagement surfaces 210, 326 can engage one another (i.e. directly contact each other) so as to align the main body 12 and the booster seat 300 with one another as the main body 12 and booster seat 300 are coupled to one another. In addition, or alternatively, the engagement surfaces 210, 326 can engage one another so as to prevent relative movement between the main body 12 and the booster seat 300 along a direction that is perpendicular to the engagement surfaces 210, 326. The engagement surfaces 210, 326 can engage one another so as to prevent relative movement between the main body 12 and the booster seat 300 along the first direction D₁. In one example, as shown, at least one of the first and second sides 202, 204 can define at least one protrusion 212 that includes the engagement surface 210. The at least one protrusion 212 is configured to be received in at least one opening 328 of the booster seat 300 that defines the at least one engagement surface 326. In this configuration, the protrusion 212 is a male type engagement component and the opening 328 is a female type engagement component. In alternative examples (not shown), the at least one of the first and second sides 202, 204 can define at least one opening (i.e. a female type engagement component) that includes the engagement surface 210 and is configured to receive at least one protrusion (i.e. a male type engagement component) of the booster seat 300 that defines the at least one engagement surface 326.

The profiles of the engagement surfaces 210 and the engagement surfaces 326 can be complementary to one another, in one example. As shown in FIGS. 4A and 4B, the engagement surfaces 210 can have a sloped or angled profile. Likewise, as shown in FIG. 6B, the engagement surfaces 326 can also have a sloped or angled profile, which is complementary to the sloped or angled profile of the engagement surfaces 210. One of ordinary skill in the art would understand that other profiles or mating configurations can be provided between the engagement surfaces 210, 326. The at least one protrusion 212 can include a pair of protrusions 212 defined on opposite lateral sides of the upper end 214 of the attachment member 200, in one example. The pair of protrusions 212 can include a ramped body that is connected to a respective one of the sides 202, 204 of the attachment member 200. The pair of protrusions 212 can have a relatively low profile, and can have a height that extends less than 50% of an overall height of the sides 204. One of ordinary skill in the art would understand based on this disclosure that this value can vary.

The at least one opening 328 can include a pair of openings defined on opposing sides of the booster seat 300. As shown in FIGS. 6A and 6B, the openings 328 can be continuous with the recess 324.

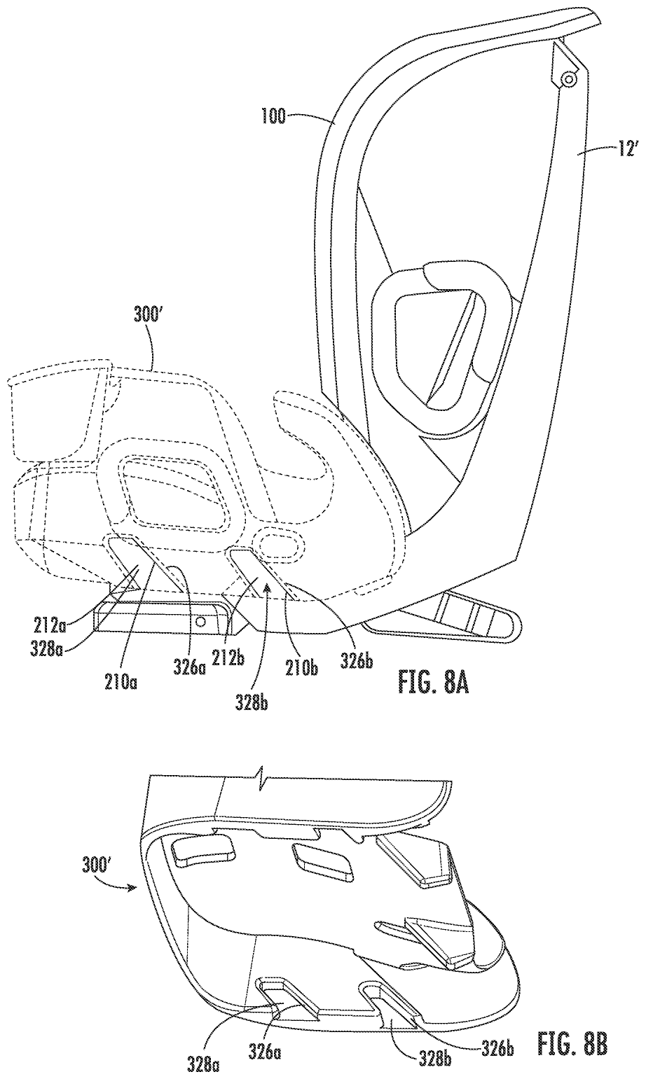

Referring to FIG. 8A, the booster seat 300′ each lateral surface on the underside of the booster seat 300′ can include a pair of openings 328a, 328b and a pair of engagement surfaces 326a, 326b. Likewise, the main body 12′ can includes two corresponding pairs of protrusions 212a, 212b, and engagement surfaces 210a, 210b. One of ordinary skill in the art would understand that each side of the booster seat 300′ and the main body 12′ can include the features shown in FIG. 8A, although only one seat of the pairs of openings 328a, 328b, protrusions 212a, 212b, and engagement surfaces 210a, 210b, 326a, 326b are shown for illustrative purposes. FIG. 8B further illustrates the underside of the booster seat 300′ in an uninstalled state.

The interface provided between the engagement surfaces 210, 326 provides additional safety features in that the booster seat and main body are prevented from separating from each other in the event of a sudden impact or collision. Increasing the amount of engagement or interface, such as by provided a plurality of engagement surfaces 210a, 210b, 326a, 326b in FIGS. 8A and 8B, can further prevent any inadvertent separation of the booster seat and the main body.

As shown in at least FIG. 1, the child safety seat 10 can comprise a harness 400 to secure a child in the child safety seat 10. The harness 400 can comprise a crotch strap 408. The crotch strap 408 can comprise a crotch buckle 406 and webbing 410. The harness 400 can comprise a first strap 402 and a second strap 404 that are configured to selectively fasten to the crotch buckle 406. The first strap 402 can comprise a lap belt portion 402a that is configured to rest over a lap of a child and/or a shoulder belt portion 402b that is configured to rest over a shoulder of a child. The first strap 402 can comprise a terminal end that is attached to the main body 12. For example, the first strap 402 can be attached to the attachment member 200 of the main body 12. Similarly, the second strap 404 can comprise a lap belt portion 404a that is configured to rest over a lap of a child and/or a shoulder belt portion 404b that is configured to rest over a shoulder of a child. The second strap 404 can comprise a terminal end that is attached to the main body 12. For example, the second strap 404 can be attached to the attachment member 200 of the main body 12. The shoulder belt portions 402b, 404b may be repositionable for differently sized children. For instance, the upper ends of the shoulder belt portions 402b, 404b can be raised for taller children, and lowered for shorter children. Thus, the shoulder belt portions 402b, 404b can have an upper-most position and a lower-most position. The attachment member 200 can include a harness release lever 218 (shown in FIG. 4A) that is configured to be engaged by a user to release the harness 400, thereby allowing the harness 400 to be loosened for a child.

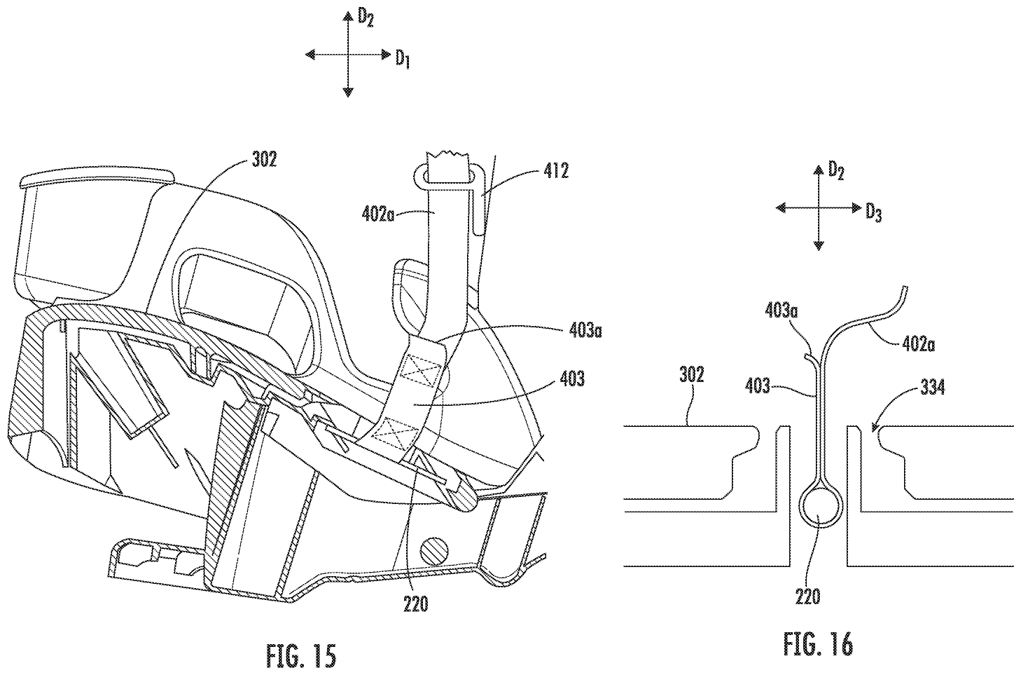

Each lap belt portion 402a, 404a can be coupled to the attachment member 200 at a location that is disposed below a seating surface 302 of the booster seat 300 when the booster seat 300 is coupled to the attachment member 200. FIGS. 15 and 16 illustrate this feature for the lap belt portion 402a, but one of ordinary skill in the art would understand that the same configuration can be provided for the other lap belt portion 404a. The harness 400 can comprise, for each lap belt portion 402a, 404a, a stiffener 403 that is attached to the lap belt portion 402a, 404a as the lap belt portion 402a, 404a extends from below the seating surface 302, out through a lap belt opening 334 in the booster seat 300, and above the seating surface 302. The stiffener 403 can be any suitable stiffener that stiffens the lower end of the lap belt portion 402a, 404a. For example, the stiffener 403 can be a webbing that is sewn or otherwise fastened to the lower end of the lap belt portion 402a, 404a. In some examples, the child safety seat 10 can comprise an anchor 220, such as a rod or other protrusion, that is disposed below the seating surface 302. The anchor 220 can be positioned internally within the attachment member 200, in one example. In one configuration, the lap belt portion 402a, 404a can be looped around the anchor 220 and stitched back on itself as shown in FIG. 16 to couple to the anchor 220. In other examples, the stiffener 403 can be a coating that is applied to the lower end of the lap belt portion 402a, 404a or a sheath that surrounds the lower end of the lap belt portion 402a, 404a. The stiffener 403 allows the lower end of the lap belt portion 402a, 404a to stand upright as the booster seat 300 is coupled to the attachment member 200 such that the lower end of the lap belt portion 402a, 404a can easily be received in the lap belt opening 334 in the booster seat 300.

Each stiffener 403 may optionally define a stop 403a that is configured to interfere with a latch 412 of the harness 400 so as to prevent the latch 412 from moving down the lap belt portion 402a, 404a to the lower end of the lap belt portion 402a, 404a. The stop 403a can be disposed at an upper end of the stiffener 403. In one example, the stop 403a can be defined by an end of the stiffener 403, such as a loose end of webbing, just above a position where the webbing is stitched to the lap belt portion 402a, 404a. The latches 412 can be provided on each of the straps 402, 404 and can be configured to secure the straps 402, 404 relative to the crotch buckle 406. The latches 412 can be releasably secured or fastened to the crotch buckle 406 to secure a child in the child safety seat 10.

Referring to FIGS. 4A and 4B, the attachment member 200 can define a pocket 216 therein. The pocket 216 can be configured to receive and store the crotch buckle 406 therein when the crotch buckle 406 is not being used to buckle a child in the child safety seat 10. For example, the crotch buckle 406 can be stowed in the pocket 216 when the child safety seat 10 is used as a forward-facing booster seat, without the harness 400. The webbing 410 of the crotch strap 408 can be attached to the attachment member 200 within the pocket 216. For example, the webbing 410 can be attached to an inner surface of the pocket 216. The inner surface can be, for example, a bottom surface or side surface of the pocket 216. In some examples, the pocket 216 can be configured such that, when the crotch buckle 406 is received therein, the crotch buckle 406 protrudes above the pocket 216. This can make the crotch buckle 406 more accessible to a user through a crotch buckle opening 332 (shown in FIG. 5) in the booster seat 300 when the booster seat 300 is coupled to the attachment member 200. Alternatively, the pocket 216 can include a cover which can be closed to store the crotch buckle 406 when not in use.

Referring to FIGS. 5, 6A, 6B, the booster seat 300 can have a front end 300a and a rear end 300b that are offset from one another along the first direction D₁. The booster seat 300 can have an upper end 300c and a lower end 300d that are offset from one another along the second direction D₂. The booster seat 300 can have a first side 300e and a second side 300f that are offset from one another along the third direction D₃. The booster seat 300 can comprise a seating surface 302. The seating surface 302 can extend from the front end 300a towards the rear end 300b. The seating surface 302 can at least partially define a receiving space 304 configured to receive a lower body of a child. The booster seat 300 can define at least one recess 324 therein that is configured to receive the attachment member 200 of the main body 12. The at least one recess 324 can extend into the rear end 300b towards the front end 300a. In some examples, the at least one recess 324 can additionally extend into the lower end 300d towards the seating surface 302.

The arms 316(1), 316(2) of the booster seat 300 can optionally define lap belt guides (also referred to herein as “forward-facing lap belt guides”) that are configured to position a lap belt portion of a vehicle restraint when the main body 12 is in a forward facing position (i.e., facing the front of the vehicle). The arms 316(1) and 316(2) can be spaced apart from one another along the third direction D₃. Each arm 316(1) and 316(2) can extend upward from the seating surface 302.

Each arm 316(1), 316(2) can define a recess or opening 316a configured to receive a lap belt portion of a vehicle restraint such as a seatbelt. In one example, as shown, the recess or opening 316a can be open towards a front end of the arm 316(1), 316(2) such that the arm 316(1), 316(2) has an upside down “L” shape. Thus, each arm 316(1), 316(2) can have a first end 316b that is attached to a body of the booster seat 300 and a second end 316c that is free from attachment to the booster seat body. The second end 316c can be spaced from the body of the booster seat 300 so as to define a space therebetween for receiving the vehicle restraint. The arms 316(1), 316(2) can be configured to receive a vehicle restraint belt, such as a vehicle seat belt or a separate restraint belt, therethrough to attach the child safety seat 10 to a vehicle seat in a forward-facing position. The receiving space 304 for the child can also be defined between the arms 316(1), 316(2).

At least one of the first and second arms 316(1), 316(2) can be disposed adjacent to a lower end 106b of a corresponding sidewall 106(1), 106(2) of the main body 12 when the booster seat 300 is coupled to the main body 12. In some examples, each of the first and second arms 316(1), 316(2) can define a surface that faces a lower end 106b of a corresponding sidewall 106(1), 106(2). At least one of the first and second arms 316(1), 316(2), and preferably both, is configured to attach to the lower end 106b of a corresponding sidewall 106(1), 106(2). For example, at least one of the first and second arms 316(1) and 316(2), and preferably both, can be configured to directly attach to a corresponding one of the sidewalls 106(1), 106(2) of the main body 12.

Referring to FIGS. 5, 6A, and 6B, in addition, or alternatively, the booster seat 300 can comprise at least one pair of armrests 318(1), 318(2). The armrests 318(1), 318(2) can be spaced apart from one another along the third direction D₃. Each armrest 318(1), 318(2) can be spaced from a respective one of the arms 316(1), 316(2) along the first direction D₁. The receiving space 304 can be defined between the armrests 318(1), 318(2). In some examples, the booster seat 300 can comprise at least one object holder, such as a pair of object holders 330(1), 330(2). At least one of the object holders 330(1), 330(2) can be a cupholder. In some examples, at least one of the object holders 330(1),330(2) can be an object holder other than a cupholder, such as a snack holder. Each object holder 330(1), 330(2) can be disposed forward of a corresponding one of the armrests 318(1), 318(2) and/or a corresponding one of the arms 316(1), 316(2). A perimeter of each of the recesses or openings 316a can be partially defined by the armrests 318(1), 318(2), as well as the arms 316(1), 316(2).

At least one, and preferably both, of the first and second arms 316(1), 316(2) can comprise the second coupler 320(1), 320(2) that is configured to couple to the first coupler 108 of a corresponding sidewall 106(1), 106(2) of the main body 12. FIG. 6A shows one example in which each second coupler 320(1), 320(2) defines an opening, and each first coupler 108 of the main body 12 is a protrusion that is configured to be received in a corresponding one of the couplers 320(1), 320(2) of the booster seat 300. Each second coupler 320(1), 320(2) can extend into a corresponding one of the first and second arms 316(1), 316(2). For example, each second coupler 320(1), 320(2) can extend into a surface of a corresponding one of the first and second arms 316(1), 316(2), where the surface faces one of the sidewalls 106(1), 106(2). Each second coupler 320(1), 320(2) can extend into a rear end of a corresponding one of the first and second arms 316(1), 316(2) along the first direction D₁. Additionally, or alternatively, each second coupler 320(1), 320(2) can extend into a corresponding one of the first and second arms 316(1), 316(2) along the second direction D₂. It will be understood that, in alternative examples, each second coupler 320(1), 320(2) could be otherwise configured. For example, each second coupler 320(1), 320(2) of the booster seat 300 could define a protrusion, and each first coupler 108 of the main body 12 could define an opening that is configured to be received in a corresponding one of the second couplers 320(1), 320(2).

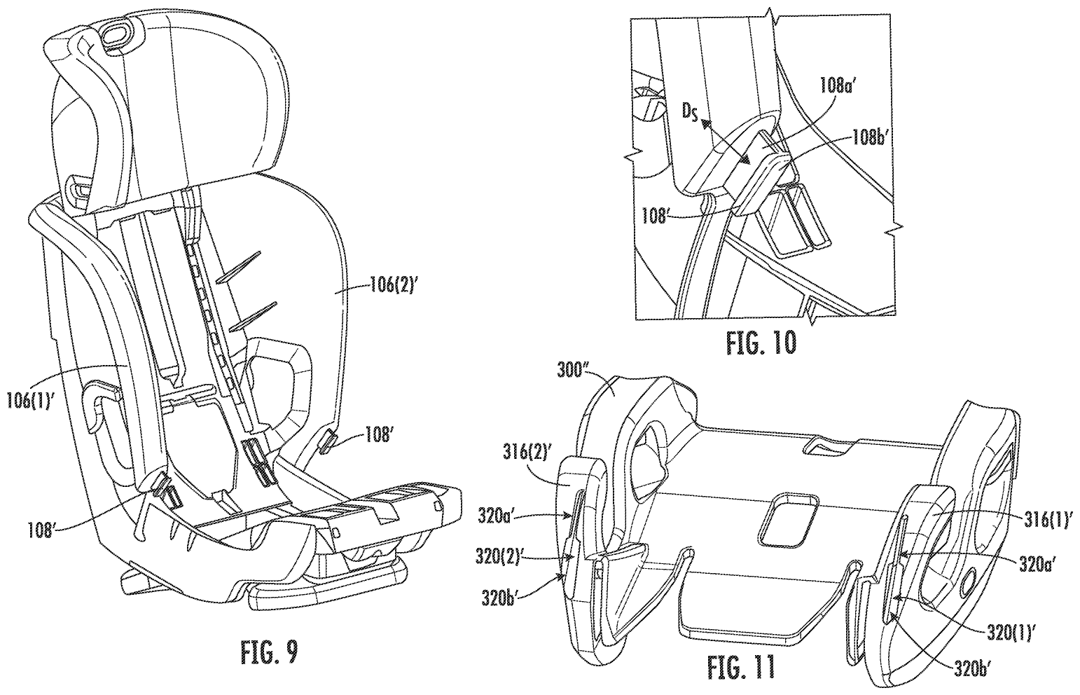

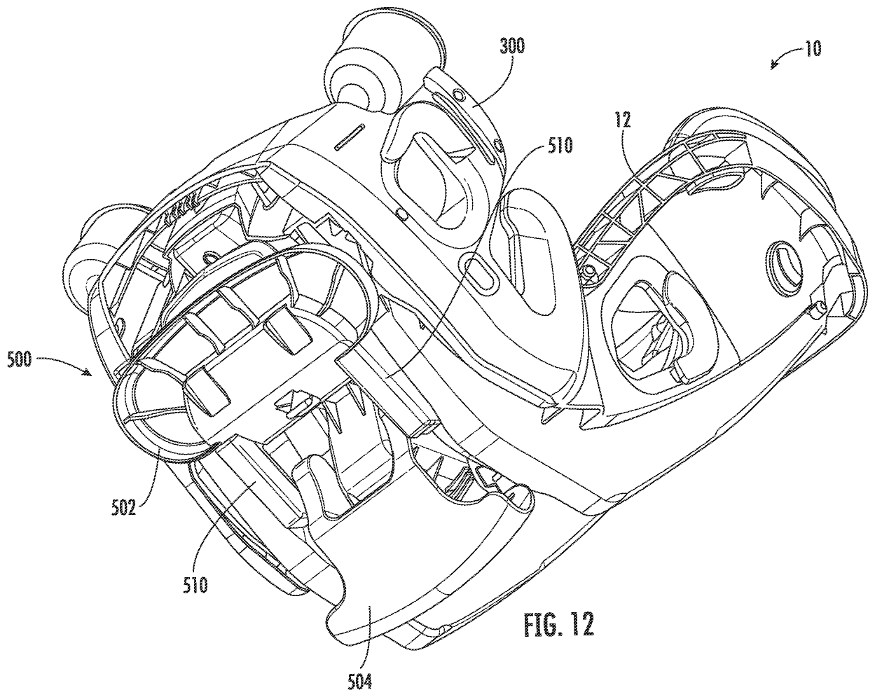

Another exemplary configuration for coupling the booster seat 300″ to the main body 12 is shown in FIGS. 9, 10 and 11. In this example, each first coupler 108′ (which in this example is formed as a protrusion) has a shape that is configured to prevent the first coupler 108′ from being removed from a corresponding second coupler 320(1)′, 320(2)′ along a select direction D_{S} that extends from a corresponding one of the arms 316(1)′, 316(2)′ to a corresponding one of the sidewalls 106(1)′, 106(2)′ and/or along the first direction D₁. In other words, each first coupler 108′ and corresponding second coupler 320(1)′, 320(1)′ can engage one another to prevent a corresponding one of the arms 316(1)′, 316(2)′ from being pulled away from a corresponding one of the sidewalls 106(1)′, 106(2)′ along the select direction D_{S}. For instance, each first coupler 108′ can have a first portion 108a′, and a second portion 108b′ that is disposed outwardly of the first portion 108a′ along the select direction D_{S}. The second portion 108b′ can have a cross-sectional dimension in a plane that is perpendicular to the select direction D_{S}, where the cross-sectional dimension is greater than a cross-sectional dimension of the first portion 108a′. The first portion 108a′ can be considered to be a neck and the second portion 108b′ can be considered to be a head. The head can be configured to be retained within the corresponding second coupler 320(1)′, 320(2)′ so as to prevent the corresponding arm 316(1)′, 316(2)′ and sidewall 106(1)′, 106(2)′ from being pulled away from one another. The first coupler 108′ can have a T-shape in a cross-sectional plane, although other shapes are contemplated within the scope of this disclosure.

Each second coupler 320(1)′, 320(2)′ can have a first portion 320a′, and a second portion that is spaced inwardly from the first portion 320a′ along the select direction D_{S}. The first portion 320a′ of the opening can be configured to receive the first portion 108a′ of the first coupler 108′, and the second portion of the opening can be configured to receive the second portion 108b′ of the first coupler 108′. The second portion of the opening can have a cross-sectional dimension in a plane that is perpendicular to the select direction D_{S}, where the cross-sectional dimension is greater than a cross-sectional dimension of the first portion 320a′ of the opening. The first portion 320a′ of the opening can have a cross-sectional dimension in a plane that is perpendicular to the select direction D_{S}, where the cross-sectional dimension is greater than that of the first portion 108a′ (e.g., neck) of the first coupler 108′ but less than that of the second portion 108b′ of the coupler 108′. Each second coupler 320(1)′, 320(2)′ can have a T-shape in a cross-sectional plane, although other shapes are contemplated within the scope of this disclosure. Each second coupler 320(1)′, 320(2)′ can also have a third portion 320b′ that is open to the first and second portions. The third portion 320b′ can have a cross-sectional dimension in a plane that is perpendicular to the select direction D_{S}, where the cross-sectional dimension is greater than that of the second portion 108b′ (e.g., head) of the first coupler 108′ so as to allow the first coupler 108′ to be inserted through the third portion 320b′ and into the first portion 320a′ of the second coupler 320(1)′, 320(2)′. The shape or profile of the first couplers 108′ and the second couplers 320(1)′, 320(2)′ can be complementary with each other.

In some examples, the booster seat 300 can define first and second belt guides 322(1), 322(2) (also referred to herein as “rear-facing belt guides”) that are configured to position at least a portion of a vehicle restraint when the main body 12 is in a rear facing position (i.e., facing the rear of the vehicle). The first rear-facing belt guide 322(1) can extend through a first side of the booster seat 300, and the second rear-facing belt guide 322(2) can extend through a second side of the booster seat 300. Thus, the first and second rear-facing belt guides 322(1), 322(2) can be spaced from one another along the third direction D₃. The first and second rear-facing belt guides 322(1), 322(2) can be configured to receive a vehicle restraint belt, such as a vehicle seat belt or a separate restraint belt, therethrough to attach the child safety seat 10 to a vehicle seat in a rear-facing position. When the booster seat 300 is installed with the main body 12, the first and second rear-facing belt guides 322(1), 322(2) can be positioned closer to the front end 14 of the main body 12 than the rear end 16. The first and second rear-facing belt guides 322(1), 322(2) can be spaced closer to the front end 14 of the main body 12 than the first and second arms 316(1), 316(2).

The booster seat 300 can comprise a first inner side surface 325(1) and a second inner side surface 325(2) that are spaced apart from one another along the third direction D₃ and defined on an underside of the booster seat 300. A front surface 325(3) can extend between the first and second inner side surfaces 325(1), 325(2) to connect the first and second inner side surfaces 325(1), 325(2). The first and second inner side surfaces 325(1), 325(2), along with the front side surface 325(3) can partially define the at least one recess 324 therebetween. At least one, and preferably both, of the first and second inner side surfaces 325(1), 325(2) can define the at least one engagement surface 326 that is configured to engage the corresponding engagement surface 210 of the main body 12. In one example, each engagement surface 326 can be angled upwards as it extends along a forward direction. The engagement surfaces 210, 326 can engage one another so as to align the main body 12 and the booster seat 300 with one another as the main body 12 and booster seat 300 are coupled to one another. In addition, or alternatively, the engagement surfaces 210, 326 can engage one another so as to prevent relative movement between the main body 12 and the booster seat 300 along a direction that is perpendicular to the engagement surfaces 210 and 326. The engagement surfaces 210, 326 can engage one another so as to prevent relative movement between the main body 12 and the booster seat 300 along the first direction D₁. In one example, as shown, at least one, and preferably both, of the first and second inner side surfaces 325(1), 325(2) can include the at least one opening 328 that is defined by a corresponding one of the engagement surfaces 326, where the at least one opening 328 is configured to receive the at least one protrusion 212 of the main body 12. In alternative examples (not shown), the at least one, and preferably both, of the first and second inner side surfaces 325(1), 325(2) can define at least one protrusion that defines a corresponding one of the engagement surfaces 326, where the at least one protrusion is configured to be received in at least one opening of the main body 12.

Referring to FIGS. 5, 6A, and 6B, the booster seat 300 can define a plurality of openings that are configured to interface with the harness 400. For instance, the booster seat 300 can define the crotch buckle opening 332 that extends through the seating surface 302. The crotch buckle opening 332 can be open to the recess 324. The crotch buckle opening 332 can be at least partially aligned with the pocket 216 of the main body 12 when the booster seat 300 is attached to the main body 12, thereby allowing a user to pull the crotch buckle 406 out of the pocket 216 and through the crotch buckle opening 332 such that the webbing 410 extends through the crotch buckle opening 332 and the crotch buckle 406 is disposed above the seating surface 302.

Additionally, or alternatively, the booster seat 300 can define at least one lap belt opening 334, each configured to receive a lap belt portion 402a, 404a of one of the first and second straps 402, 404 therethrough. Each lap belt opening 334 can extend into a rear end of the booster seat 300. The lap belt opening 334 can be formed as a slot that extends into the seating surface 302. Additionally, or alternatively, the booster seat 300 can define at least one opening 336 aligned with the harness release lever 218 to allow the user to access the harness release lever 218. The at least one opening 336 can be defined as an opening on the seating surface 302, and preferably be defined on the front end 300a of the booster seat 300.

The booster seat 300 can comprise at least one foot 342 that extends down from the seating surface 302 at the rear end of the booster seat 300. The at least one foot 342 can provide structural support to the rear end of the seating surface 302 when the booster seat 300 is used separately from the main body 12. The at least one foot 342 can be configured to engage with a chair surface, ground surface, or other surface such that the booster seat 300 is stable and free-standing. The at least one foot 342 can be formed on a cantilevered portion 302a of the seating surface 302. The at least one foot 342 can be disposed between the lap belt openings 334. The attachment member 200 can comprise at least one opening 222 (labeled in FIG. 4B) therein that is configured to receive at least a portion of the at least one foot 342 when the booster seat 300 is coupled to the attachment member 200. The at least one foot 342 and the at least one opening 222 can engage one another so as to guide movement of the booster seat 300 towards the attachment member 200 as the booster seat 300 is coupled to the attachment member 200 (e.g., align the booster seat 300 and attachment member 200 with one another).

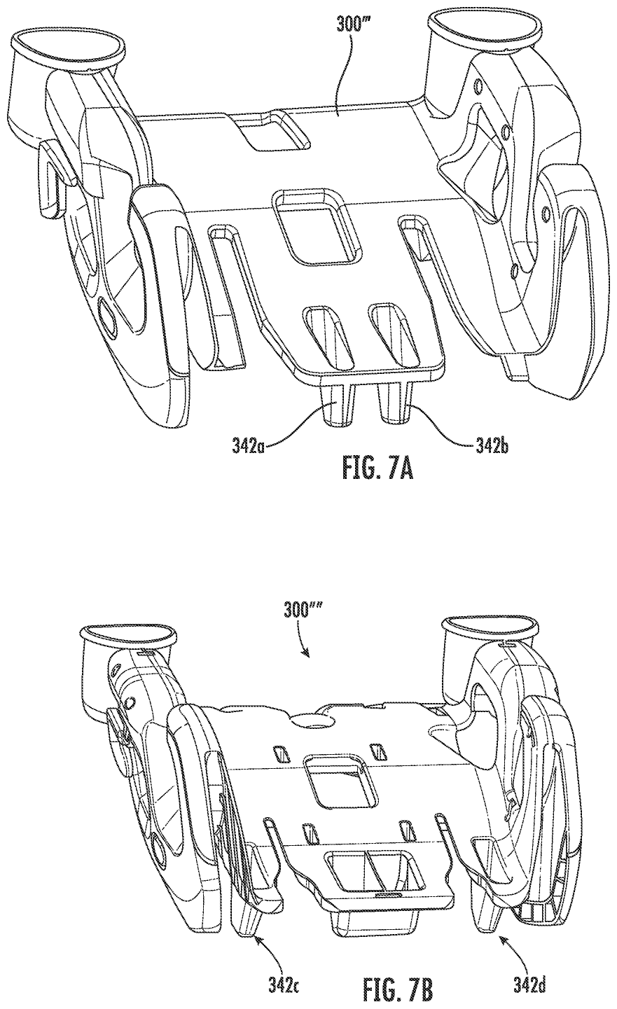

Referring to FIG. 7A, a booster seat 300′″ can include two feet 342a, 342b that are formed as fins or spaced apart protrusions defined on an underside of the booster seat 300′″. The two feet 342a, 342b otherwise function the same as the at least one foot 342 described herein. Referring to FIG. 7B, a booster seat 300″″ can include additional feet 342c, 342d that are formed as fins or spaced apart protrusions defined on an underside of the booster seat 300″″ at different locations toward the rear end of the booster seat 300″″.

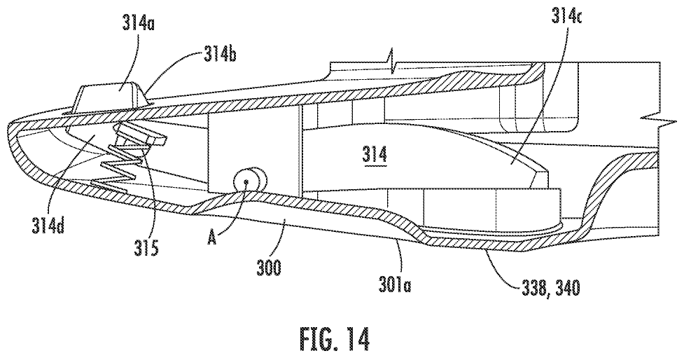

Referring to FIGS. 6A, 6B, and 14, the booster seat 300 can comprise at least one release latch 314 (shown in detail in FIG. 14) that is configured to selectively engage the main body 12 so as to fix the booster seat 300 and main body 12 to one another. The release latch 314 can fix the booster seat 300 and main body 12 to one another with respect to movement along at least one, and up to all, of the first direction D₁, the second direction D₂, and the third direction D₃. The release latch 314 can be integrated on a portion of the booster seat 300. The booster seat 300 can comprise an actuator surface 338 for each release latch 314 that is configured to be engaged by a user to unlatch the release latch 314, thereby allowing the booster seat 300 to be removed from the main body 12. In one example, the actuator surface 338 can be defined by an actuator button 340. The actuator button 340 can be configured to be depressed into an outer surface of the booster seat 300. For example, the actuator button 340 can be depressed into an outer side surface 301a or a front surface 301b of a body 301 of the booster seat 300. In some examples, the booster seat 300 can comprise a pair of release latches 314, one disposed on either side 300e and 300f of the booster seat 300.

As shown in FIG. 14, each release latch 314 can comprise an engagement surface 314a that is configured to engage an engagement surface of the main body 12 so as to fix the booster seat 300 and the main body 12 to one another with respect to movement along at least one, and up to all, of the first direction D₁, the second direction D₂, and the third direction D₃. FIG. 14 shows one example of the release latch 314; however, it will be understood that the release latch 314 can be implemented in any other suitable manner.

In one example, the release latch 314 can comprise a protrusion 314b that defines the engagement surface 314a, and the main body 12 can define a recess 317 (shown in FIG. 4D) that receives the protrusion 314b. The engagement surface 314a can be biased towards the main body 12 by a spring 315 or other known biasing element. The release latch 314 can be configured such that, when the actuator surface 338 is engaged by a user, the engagement surface 314a of the release latch 314 retracts at least partially into the booster seat 300 and disengages from the main body 12.

The release latch 314 can comprise a first end 314c and a second end 314d. The first end 314c can comprise the actuator surface 338. The second end 314d can comprise the engagement surface 314a. The release latch 314 can be pivotably coupled to the body 301 of the booster seat 300 at a pivot axis A that is between the first and second ends 314c, 314d of the release latch 314. The pivot axis A can extend along, for example, the second direction D₂ or the third direction D₃.

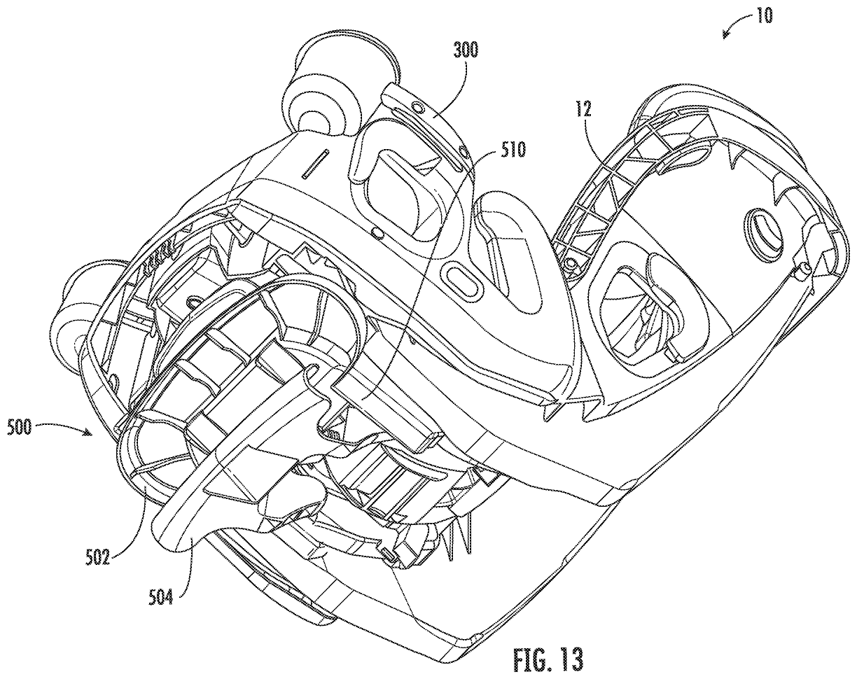

Referring to FIGS. 12 and 13, in some examples, the child safety seat 10 can comprise a recline base 500. The recline base 500 can be configured to transition the child safety seat 10 between at least one upright position (e.g., FIGS. 2 and 12) and at least one reclined position (e.g., FIGS. 3 and 13). The recline base 500 can have any suitable configuration. In some examples, the recline base 500 can have at least one recline foot 502, 504. In some of such examples, the recline base 500 can have a first recline foot 502 and a second recline foot 504. A description of one such a recline base is provided in U.S. Patent Publication 2020/0223332, published Jul. 16, 2020, the entire contents of which are hereby incorporated by reference as if set forth in their entirety herein.

In alternative examples (not shown), the main body 12 can have a bottom surface that is curved, and the recline base 500 can comprise an upper surface that is curved to conform to the bottom surface of the main body 12. The bottom surface of the main body 12 can be configured to translate along the upper surface of the recline base 500 to transition the main body 12 between the at least one upright position and the at least one reclined position.

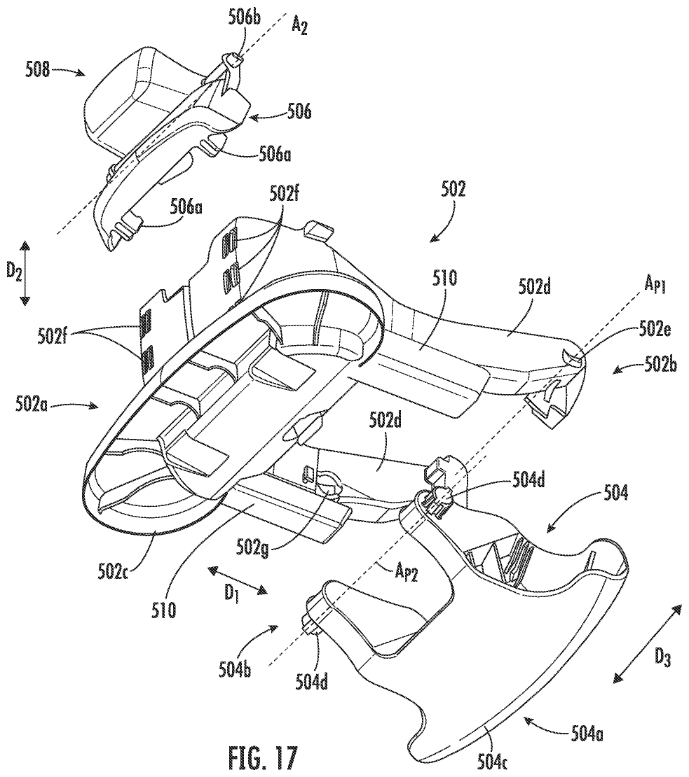

Referring to FIG. 17, the first recline foot 502 can comprise a front end 502a and a rear end 502b. The front end 502a can comprise an engagement region 502c that defines a surface configured to engage a vehicle seat 600, or any other support surface or the ground when the seat is not installed with a vehicle. The rear end 502b can be disposed behind the front end 502a and the engagement region 502c. The engagement region 502c can be enlarged relative to the rear end 502b. For example, the engagement region 502c can have a width along the third direction D₃ that is greater than a width of the rear end 502b. The engagement region 502c can be elongated along the third direction D₃. The rear end 502b can be coupled to the main body 12 of the child safety seat 10 such that the first recline foot 502 is configured to pivot relative to main body 12 about a pivot axis A_{P1} to transition the main body 12 between at least one reclined position and at least one inclined position. The first recline foot 502 can be configured to pivot such that the front end 502a moves towards and away from the front end 14 of the main body 12 along the second direction D₂.

The rear end 502b can include at least one coupler 502e that is configured to pivotably couple the first recline foot 502 to the main body 12. The at least one coupler 502e can be any suitable coupler. In one example, the at least one coupler 502e can be a protrusion that is configured to be received in at least one opening in the main body 12. In another example (not shown), the at least one coupler 502e can be an opening that is configured to receive a protrusion of the main body 12. The rear end 502b can have at least one rigid portion 502d that freely extends cantilevered from the engagement region 502c. For example, the rear end 502b can include a pair of rigid portions 502d that are offset from one another along the third direction D₃ so as to define a space therebetween. Each rigid portion 502d can define an arm that extends rearward from the front end 502a. Each rigid portion 502d can be configured such that it does not engage the vehicle seat 600. Each rigid portion 502d can comprise at least one of the couplers 502e.

The recline base 500 can comprise a recline lock 506 and a recline actuator 508. The recline lock 506 can be configured to releasably lock the first recline foot 502 in a plurality of different positions. The recline actuator 508 can be configured to be engaged by a caregiver to transition the recline lock 506 between a locked position in which the position of the first recline foot 502 is fixed relative to the main body 12, and an unlocked position in which the first recline foot 502 is pivotable relative to the main body 12. The recline actuator 508 can define a push button or handle that is configured to be engaged by the caregiver. The recline actuator 508 can be any suitable actuator, and the recline lock 506 can be any suitable lock.

In one example, as shown, the recline lock 506 can comprise at least one protrusion 506a and the front end 502a of the first recline foot 502 can comprise a surface that defines at least one set of openings 502f that are configured to selectively receive the at least one protrusion 506a. As shown in FIG. 17, the openings 502f can be defined in at least two parallel sets. Each set of the openings 502f can include a series of openings 502f aligned with each other in the second direction D₂. Each opening 502f in the set can correspond to a different position of the first recline foot 502. In some examples, the recline lock 506 can comprise a plurality of protrusions 506a that are offset from one another along the third direction D₃, and the first recline foot 502 can define a plurality of sets of openings 502f, each set being offset from one another along the third direction D₃. The recline lock 506 can be biased into the locked position by a biasing element (not shown) such as a spring. The recline lock 506 can be configured to pivot about a pivot axis AL between the locked and unlocked positions. The pivot axis AL can extend along the third direction D₃. The recline lock 506 can include a coupler 506b that is configured to be connected to a portion of the first recline foot 502, a portion of the main body 12, or other structure.

The second recline foot 504 can comprise a first end 504a and a second end 504b. The first end 504a can comprise an engagement region 504c defining a surface that is configured to engage a vehicle seat 600, or any other support surface or the ground when the seat is not installed with a vehicle. The second end 504b can be coupled to either the first recline foot 502 or to the main body 12 of the child safety seat 10 such that the second recline foot 504 is configured to pivot relative to main body 12 about a pivot axis A_{P2}. The first recline foot 502 can be configured to pivot up to a first maximum angle (e.g., less than 90 degrees), and the second recline foot 504 can be configured to pivot up to a second maximum angle (e.g., greater than 90 degrees) that is greater than the first maximum angle. The second recline foot 504 can be configured to pivot such that the first end 504a moves between a rearward-oriented position and a forward-oriented position. In some examples, the second recline foot 504 can be configured to pivot without causing the first recline foot 502 to pivot.

The second end 504b can include at least one coupler 504d that is configured to pivotably couple (about pivot axis A_{P2}) the second recline foot 504 to the main body 12 or the first recline foot 502. The at least one coupler 504d can be any suitable coupler. In one example, the at least one coupler 504d can be a protrusion that is configured to be received in at least one opening 502g in the first recline foot 502 or the main body 12. For instance, each opening 502g can be defined in a rigid portion 502d of the first recline foot 502. In another example (not shown), the at least one coupler 504d can be an opening that is configured to receive a protrusion of the first recline foot 502 or the main body 12.

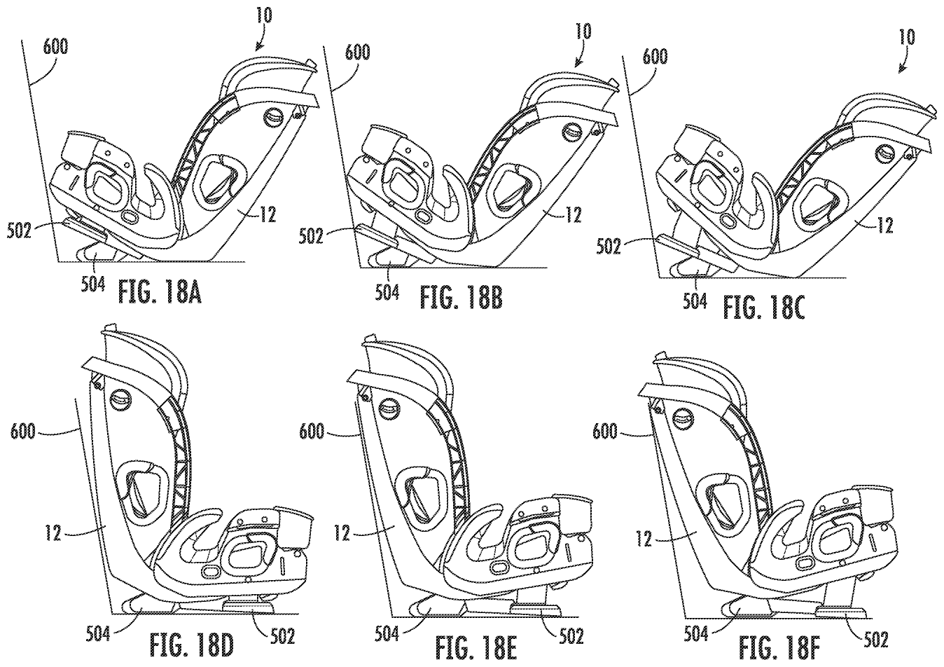

Referring to FIG. 18A-18F, the child safety seat 10 can be installed on the vehicle seat 600 in a rearward-facing orientation (orientations shown in FIGS. 18A-18C) or in a forward-facing orientation (orientations shown in FIGS. 18D-18F). Within each orientation, the child safety seat 10 can be positioned in a plurality of different recline positions. For instance, in the rearward-facing orientations shown in FIGS. 18A-18C (rearward relative to the vehicle seat 600), the second recline foot 504 can be pivoted to the forward-oriented position (forward relative to the child safety seat 10), and the first recline foot 502 can be pivoted to one of a plurality different recline positions. As shown in orientations of FIGS. 18A-18C, the first recline foot 502 can rest on or above the second recline foot 504 such that the first recline foot 502 does not contact the vehicle seat 600. The child safety seat 10 can be reclined by pivoting the first recline foot 502 away from the main body 12, while the second recline foot 504 remains in a forward-oriented position.

In the forward-facing orientations shown in FIGS. 18D-18F (forward relative to the vehicle seat 600), the second recline foot 504 can be pivoted to the rearward-oriented position (rearward relative to the child safety seat 10), and the first recline foot 502 can be pivoted to one of a plurality different recline positions. As shown in orientations of FIGS. 18D-18F, the second recline foot 504 is pivoted so that the first recline foot 502 can rest on the vehicle seat 600 as opposed to on the second recline foot 504. In the forward-facing orientation, the child safety seat 10 can be reclined by pivoting the first recline foot 502 away from the main body 12. In the configuration shown in FIGS. 18D-18F, both the first recline foot 502 and the second recline foot 504 rest on the vehicle seat 600. In one example, the second recline foot 504 can be configured to engage the vehicle seat 600, regardless of the configuration or orientation of the child safety seat 10, while the first recline foot 502 selectively engages the vehicle seat 600 depending on the orientation or configuration of the child safety seat 10.

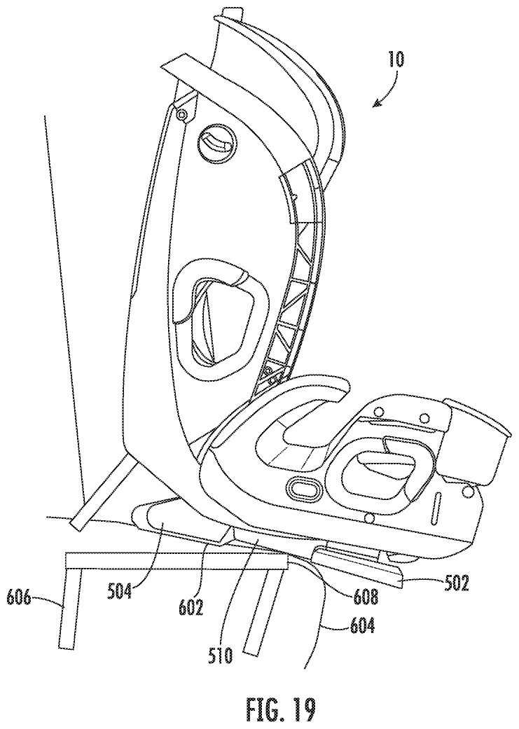

Referring to FIG. 19, a side view is shown of a position of the child safety seat 10 on a vehicle seat 600 during a vehicular accident, such as a front-end collision. As shown, during the collision, the child safety seat 10 rotates forwards and downwards. This causes the child safety seat 10 to compress cushioning 604 of a seat pan 602 until a force is applied by a front end 608 of a frame 606 of the vehicle seat 600 to the at least one rigid portion 502d of the first recline foot 502. This force can prematurely stop the rotation of the child safety seat 10, resulting in an undesirably high head injury criterion (HIC) value and/or an undesirably high chest G-force value as measured under the Federal Motor Vehicle Safety Standard 213 (FMVSS 213).

To lower the HIC value and/or chest G-force value, the child safety seat 10 can comprise at least one deformable body 510 that absorbs energy from the impact of the child safety seat 10 against the front end 608 of the vehicle seat frame 606. The at least one deformable body 510 can be formed on the underside of the attachment member 200. For example, each side 202, 204 of the attachment member 200 can define deformable ribs (not shown) that extend into the bottom of the attachment member 200 and that are configured to deform in response to impact from the frame 606 of the vehicle seat 600. However, the bottom of the attachment member 200 is smaller than would otherwise be necessary if the child safety seat 10 did not include the removable booster seat 300. As a result, the deformable ribs extending into the bottom of the attachment member 200 would not be tall enough to provide sufficient energy absorption in the event of a vehicular accident.

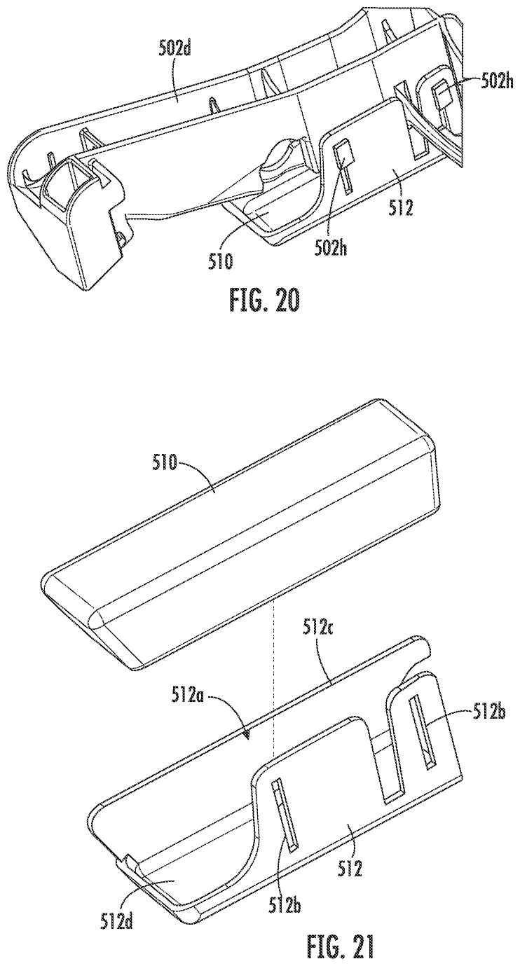

Therefore, to provide sufficient energy absorption to satisfy, for example, FMVSS 213, the at least one deformable body 510 can be affixed to the at least one rigid portion 502d of the first recline foot 502, such as to an underside of the at least one rigid portion 502d. In some examples, the at least one deformable body 510 can comprise first and second deformable bodies 510 that are each affixed to first and second rigid portions 502d, respectively, of the first recline foot 502. In some examples, each of the at least one deformable body 510 can be a separate body that is coupled to a corresponding rigid portion 502d. For example, as shown in FIGS. 20 and 21, the deformable body 510 can be formed from a deformable material, such as expanded polystyrene (EPS). The deformable body 510 can have a density that is less than a density of the at least one rigid portion 502d. The deformable body 510 can be configured to engage the vehicle seat 600 (such as front end 608 of frame 606) and deform under a lower force than the at least one rigid portion 502d. In other words, a first predetermined force can be configured to deform the deformable body 510 and a second predetermined force can be configured to deform the rigid portion 502d, and the first predetermined force can be less than the second predetermined force. In one example, the rigid portion 502d is more rigid than the deformable body 510. The child safety seat 10 can comprise a holder 512 for each of the at least one deformable body 510. Each holder 512 can be formed from a material, such as polypropylene, that is more rigid than the material of the at least one deformable body 510. Each holder 512 can define a cover that is configured to protect a respective deformable body 510 to prevent damage to the deformable body 510 due to inadvertent impacts. Each holder 512 can define a recess 512a therein that is configured to receive a respective deformable body 510 therein. Each recess 512a can extend into an upper end 512c of the holder 512 towards a bottom end 512d of the holder 512.

Each holder 512 can be movably coupled to the first recline foot 502. For example, each holder 512 can be configured to move relative to the first recline foot 502 along an upwards direction so as to allow the respective deformable body 510 to deform between the holder 512, such as the bottom end 512d of the holder 512, and a respective rigid portion 502d. The recess 512a of each holder 512 can be configured to receive a respective rigid portion 502d therein as the holder 512 moves upwards relative to the rigid portion 502d (i.e., as energy is absorbed by the deformable body 510.

The child safety seat 10 can comprise at least one coupler 512b for each holder 512 that is configured to movably couple the holder 512 to a respective rigid portion 502d. Each coupler 512b can be any suitable coupler. In one example, each coupler 512b can be a first one of a protrusion or an opening, and the respective rigid portion 502d can have a coupler 502h that defines a second one of a protrusion or an opening that is configured to engage the first one of the protrusion or the opening. The opening can be a slot that is elongated along the second direction D₂, and the protrusion can be configured to translate within the slot along the second direction D₂ so as to allow the holder 512 to translate upwards relative to the first recline foot 502.

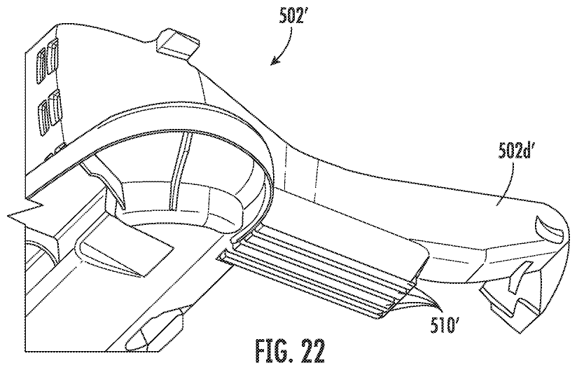

Referring to FIG. 22, in another example, the at least one deformable body 510′ can be integral and monolithic with a corresponding rigid portion 502d′ of the first recline foot 502′. In some such examples, the deformable body 510′ can define a plurality of deformable walls or ribs as shown, or another suitable deformable structure. The deformable structure can have deformable walls, such as a honeycomb structure (not shown). The deformable structure can be integral and monolithic with the at least one rigid portion 502d′. The deformable structure can be configured to deform under a lower force than the remainder of the at least one rigid portion 502d′.

A method of installing a booster seat to a main body of a child car seat is also disclosed herein. The method can comprise positioning the booster seat relative to the main body such that first and second arms of the booster seat engage with sidewalls of the main body. This engagement interface can both position the booster seat relative to the main body, and ensure a secure and reliable connection between the main body and the booster seat in the event of a collision or accident. Engagement between the arms of the booster seat and the sidewalls of the main body can be provided in a variety of configurations, as described herein. The method can further comprise selectively releasing the booster seat from the main body, such as via a release latch and an actuator. The actuator can be formed on a portion of the booster seat that is accessible when the booster seat is fully installed with the main body.

The method can further include adjusting the main body and/or booster seat, such as via a recline base or assembly. The method can include adjusting a relative position of at least one recline foot, that may be configured to selectively engage a vehicle support surface at various angles and positions. At least one portion of the recline base can include a deformable body that is configured to absorb energy and protect the occupant of the child car seat in the event of an accident or collision.

It should be noted that the illustrations and descriptions of the examples and embodiments shown in the figures are for exemplary purposes only, and should not be construed limiting the disclosure. One skilled in the art will appreciate that the present disclosure contemplates various embodiments. Additionally, it should be understood that the concepts described above with the above-described examples and embodiments may be employed alone or in combination with any of the other examples and embodiments described above. It should further be appreciated that the various alternative examples and embodiments described above with respect to one illustrated embodiment can apply to all examples and embodiments as described herein, unless otherwise indicated.

Unless explicitly stated otherwise, each numerical value and range should be interpreted as being approximate as if the word “about,” “approximately,” or “substantially” preceded the value or range. The terms “about,” “approximately,” and “substantially” can be understood as describing a range that is within 15 percent of a specified value unless otherwise stated.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain examples have been described, these examples are not intended to limit the scope of the inventions disclosed herein. Thus, nothing in the foregoing description is intended to imply that any particular feature, characteristic, step, module, or block is necessary or indispensable. Indeed, the novel arrangements, methods, and systems described herein may be embodied in a variety of other forms; furthermore, various omissions, substitutions, and changes in the form of the arrangements, methods, and systems described herein may be made without departing from the spirit of the inventions disclosed herein. The accompanying claims and their equivalents are intended to cover such forms or modifications as would fall within the scope and spirit of certain of the inventions disclosed herein.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following claims, if any, are recited in a particular sequence with corresponding labeling, unless the claim recitations otherwise imply a particular sequence for implementing some or all of those elements, those elements are not necessarily intended to be limited to being implemented in that particular sequence.

The words “inward,” “outward,” “upper,” and “lower” refer to directions toward or away from, respectively, the geometric center of the car seat and/or its components.

It will be understood that reference herein to “a” or “one” to describe a feature such as a component or step does not foreclose additional features or multiples of the feature. For instance, reference to a device having, comprising, including, or defining “one” of a feature does not preclude the device from having, comprising, including, or defining more than one of the features, as long as the device has, comprises, includes, or defines at least one of the feature. Similarly, reference herein to “one of” a plurality of features does not foreclose the invention from including two or more of the features. For instance, reference to a device having, comprising, including, or defining “one of a protrusion and a recess” does not foreclose the device from having both the protrusion and the recess.

1. A child car seat for a vehicle, the child car seat comprising:
a main body comprising a seatback having a first sidewall and a second sidewall that are spaced from one another so as to define a space therebetween for a child's upper body; and
a booster seat configured to be removably attached to the main body, the booster seat comprising first and second arms that are spaced from one another, and a seating surface between the first and second arms,
wherein the first arm is configured to removably attach to the first sidewall at an interface between the first arm and the first sidewall.

2. The child car seat of claim 1, wherein the second arm is configured to removably attach to the second sidewall at an interface between the second arm and the second sidewall.

3. The child car seat of claim 2, wherein the first arm is configured to directly attach to the first sidewall, and the second arm is configured to directly attach to the second sidewall.

4. The child car seat of claim 1, wherein the first sidewall defines a coupler and the first arm defines a coupler that is configured to engage the coupler of the first sidewall.

5. The child car seat of claim 4, wherein the coupler of the first arm defines a first one of a protrusion or an opening, and the coupler of the first sidewall defines a second one of a protrusion or an opening.

6. The child car seat of claim 4, wherein the coupler of the first sidewall defines a protrusion, and the coupler of the first arm defines an opening dimensioned to receive the protrusion.

7. The child car seat of claim 6, wherein the protrusion comprises a head that is configured to be retained within the opening so as to prevent the first sidewall and the first arm from separating from one another along at least one direction.

8. The child car seat of claim 1, wherein the first arm is configured to removably attach to the first sidewall such that at least one of: (i) inward flexion of the first arm towards the space is restricted, or (ii) outward flexion of the first arm away from the space is restricted.

9. The child car seat of claim 1, wherein the main body further comprises an attachment member, and
the booster seat further comprises a recess below the seating surface that is configured to receive the attachment member, and at least one foot that extends downwards from the seating surface and into the recess at a rear end of the seating surface, the at least one foot configured to support the rear end of the seating surface when the booster seat is decoupled from the attachment member.

10. The child car seat of claim 1, wherein the booster seat further comprising at least one release latch having an engagement surface and an actuator surface, the engagement surface being configured to releasably engage the main body so as to fix the booster seat and main body to one another, and the actuator surface being disposed at an outer side surface or a front surface of the booster seat.

11. The child car seat of claim 1, wherein the booster seat defines a pair of lap belt openings that extend into a rear end of the booster seat, and the child car seat further comprises:
a harness including a crotch buckle, and first and second straps having first and second lap belt portions, respectively, that are configured to rest over a lap of a child, wherein the harness further comprises, for each lap belt portion of the first and second lap belt portions, a stiffener that is attached to a respective one of the first and second lap belt portions, and extends with the first and second lap belt portions from below the seating surface, out through a corresponding one of the pair of lap belt openings, and above the seating surface.

12. The child car seat of claim 1, further comprising:
a first recline foot having a front end that defines an engagement region configured to engage a vehicle seat, and a rear end disposed behind the front end, the rear end being coupled to the main body such that the first recline foot is configured to pivot relative to the main body about a pivot axis to transition the main body between at least one reclined position and at least one inclined position, and
the rear end having at least one rigid portion, wherein the child car seat comprises at least one deformable body affixed to the at least one rigid portion of the first recline foot, and the at least one deformable body is configured to engage the vehicle seat and deform under a first predetermined force that is less than a second predetermined force configured to deform the at least one rigid portion.

13. A child car seat for a vehicle, the child car seat comprising:
a main body comprising a seatback and at least one attachment member that extends from the seatback; and
a booster seat comprising a seating surface, a recess below the seating surface that is configured to receive the at least one attachment member, and at least one foot that extends downwards from the seating surface and into the recess at a rear end of the seating surface, the at least one foot configured to support the rear end of the seating surface when the booster seat is decoupled from the at least one attachment member.

14. The child car seat of claim 13, wherein the at least one attachment member comprises at least one opening that is configured to receive the at least one foot when the booster seat is coupled to the at least one attachment member.

15. The child car seat of claim 14, wherein the at least one foot and the at least one opening are configured to engage one another so as to guide movement of the booster seat towards the at least one attachment member as the booster seat is coupled to the at least one attachment member.

16. The child car seat of claim 13, wherein:
the booster seat defines a pair of lap belt openings that extend into a rear end of the booster seat, the lap belt openings each being configured to receive a lap belt portion of a harness of the child car seat; and
the at least one foot is disposed between the pair of lap belt openings.

17. The child car seat of claim 13, wherein the recess extends into a rear end of the booster seat towards a front end of the booster seat, and into a lower end of the booster seat towards the seating surface.

18. The child car seat of claim 13, wherein:
the at least one attachment member has opposed outer sides, each outer side defining at least one engagement surface; and
the booster seat comprises opposed inner side surfaces, each defining at least one engagement surface that is configured to engage a corresponding one of the at least one engagement surface of the at least one attachment member so as to guide movement of the booster seat towards the at least one attachment member as the booster seat is coupled to the at least one attachment member.

19. A child car seat for a vehicle, the child car seat comprising:
a main body comprising a seatback, and at least one attachment member that extends from the seatback along a forward direction, the main body defining at least one engagement surface; and
a booster seat configured to be removably attached to the main body, the booster seat comprising at least one release latch having an engagement surface and an actuator surface, the engagement surface being configured to releasably engage the engagement surface of the main body so as to fix the booster seat and main body to one another, and the actuator surface being disposed at an outer side surface or a front surface of the booster seat.

20. The child car seat of claim 19, wherein the actuator surface is defined by an actuator button that is configured to be depressed into the outer side surface of the booster seat or the front surface of the booster seat.

21. The child car seat of claim 19, wherein the at least one release latch comprises a pair of release latches disposed on opposing sides of the booster seat.

22. The child car seat of claim 19, wherein the at least one release latch comprises a protrusion that defines the engagement surface, and the main body defines a recess that receives the protrusion.

23. The child car seat of claim 19, wherein the engagement surface of the booster seat is biased towards the main body.

24. The child car seat of claim 20, wherein the at least one release latch is configured such that, when the actuator surface is engaged by a user, the engagement surface of the at least one release latch retracts at least partially into a body of the booster seat and disengages from the main body.

25. The child car seat of claim 19, wherein the at least one release latch comprises a first end and a second end, the first end comprising the actuator surface and the second end comprising the engagement surface, wherein the at least one release latch is pivotably coupled to a body of the booster seat at a pivot axis that is between the first and second ends of the at least one release latch.

26-54. (canceled)
